(19) United States
(12) Patent Application Publication
(10) Pub. No.: US 2025/0144814 A1
(43) Pub. Date: May 8, 2025

(54) VERSATILE ADHESION-BASED GRIPPING VIA AN UNSTRUCTURED VARIABLE STIFFNESS MEMBRANE

(71) Applicant: THE TRUSTEES OF THE UNIVERSITY OF PENNSYLVANIA, Philadelphia, PA (US)

(72) Inventors: Kevin TURNER, Wayne, PA (US); Aoyi LUO, Cambridge, MA (US); Sumukh Shankar PANDE, Philadelphia, PA (US)

(21) Appl. No.: 18/832,191

(22) PCT Filed: Jan. 27, 2023
(86) PCT No.: PCT/US2023/061441

§ 371 Date: Jul. 23, 2024

Related U.S. Application Data
(60) Provisional application No. 63/304,172, filed on Jan. 28, 2022.

(51) Int. Cl. B25J 15/00; H05B 3/36

(52) U.S. Cl. CPC B25J 15/0033; H05B 3/36

(57) ABSTRACT

Variable stiffness materials with a modulus that can be tuned via an external stimulus offer a unique approach to realize dynamic control of adhesion. Here, an unstructured shape memory polymer (SMP) membrane with variable stiffness is used to pick-and-place of 3D objects. The variable stiffness of the SMP allows the membrane to conform to and make good contact with objects of various shapes in its soft state and then achieve high adhesive load capacity by switching to the stiff state. Release of objects is realized by switching to the soft state. The ratio between the high-adhesion and low-adhesion state is demonstrated (in non limiting embodiments) to be >2000 on a curved substrate and ˜115 on a flat substrate. This gripper exhibits no adhesion in non-actuated state and maintains adhesion passively once actuation is complete.

### CROSS-REFERENCE TO RELATED APPLICATIONS

The present application claims priority to and the benefit of U.S. patent application No. 63/304,172, “Versatile Adhesion-Based Gripping Via An Unstructured Variable Stiffness Membrane” (filed Jan. 28, 2022). All foregoing applications are incorporated herein by reference in their entireties for any and all purposes.

### GOVERNMENT RIGHTS

This invention was made with government support under 1663037 and 1830475 awarded by the National Science Foundation. The government has certain rights in the invention.

### TECHNICAL FIELD

The present disclosure relates to the field of reversible adhesion devices.

### BACKGROUND

A number of dry adhesion-based grippers that allow for attachment to 3D objects have been reported. Some have fabricated gecko inspired fibrillar adhesive films on a bi-stable support structure and utilized the high shear force capacity of a fibrillar adhesive to grip 3D objects. Others developed a device in which a gecko inspired fibrillar adhesive membrane was suspended above a chamber to allow the membrane to deform to accommodate to the shape of the object being contacted. Others demonstrated that the force capacity of this device could be increased by applying a negative (i.e., vacuum) pressure on the membrane.

Though most of the dry adhesion-based grippers to date rely on gecko inspired structures, there are other routes to achieve strong dry adhesion. It has been observed that the load capacity of an adhered interface scales with the square root of system stiffness times contact area. However, high system stiffness and large contact area generally cannot be achieved simultaneously, since compliance is essential for adhesives to reach large contact area. Materials with variable stiffness, which can switch between a stiff and a soft state in response to a specific stimulus, provide a unique opportunity to overcome this dilemma.

Shape memory polymers (SMPs) are a class of variable stiffness materials. Bulk SMPs with unpatterned and micropatterned surfaces supported by a planar rigid backing have been used previously to grip macro- and microscale objects. Other variable stiffness materials such as jammed granular materials, foams, liquid metals, wax, thermoplastics and hydrogels have also been used in pick-and-place applications. Though SMP adhesives with various surface structures have been engineered to achieve strong and variable interfacial adhesion, the mechanical design of SMP adhesive systems with high compliance and conformability has received relatively little attention. The compliance and conformability of the previous studied SMP adhesives are limited by the planar rigid backing. Accordingly, there is a long-felt need in the art for improved membrane-based adhesion systems and related methods.

### SUMMARY

Membranes made of low modulus materials are highly effective at adapting to and conforming to nonplanar and deformable objects because of their low axial stiffness and negligible bending stiffness. Here, we present a dry adhesion-based SMP gripper that exploits variable stiffness membrane for adhesion control (FIG. 1). The gripper is composed of an unstructured flat variable stiffness SMP membrane, which requires no microfabrication and can be manufactured via a simple casting process, supported above a pressure chamber containing a heater. During use, the SMP membrane is heated, softens, and is then pressed in to contact with the target surface. The low modulus of the SMP in the soft state allows for conformal contact with complex surfaces. After making contact, the membrane is cooled and stiffens, resulting in increased load capacity. Release of the object is achieved by heating the membrane which softens the membrane and reduces the load capacity. Through the use of the unstructured variable stiffness SMP membrane design, the gripper can adapt to objects with varying 3D shapes, achieve high load capacity and adhesion switching ratio compared to grippers based on elastomer membranes.

In meeting the described long-felt needs, the present disclosure provides a controllable gripper module, comprising: a chamber; a flexible membrane at least partially sealing the chamber, the flexible membrane being in a first state and having a first state modulus when at a first temperature (optionally an ambient temperature) being in a second state and having a second state modulus when at an elevated temperature, the flexible membrane being reversibly convertible between the first state and the second state, the conversion optionally being effected by application of heat, and the chamber optionally configured to contain a pressure within that exerts the membrane outward relative to the chamber optionally while the membrane is at the elevated temperature.

A membrane can be heated by contacting the membrane to a heated fluid (gas, liquid) or effecting heating of the membrane by way of a heated fluid. A membrane can also be heated via application of electricity, e.g., to traces on or in the membrane. Application of electricity can thus give rise to membrane heating and/or a change in membrane stiffness; the change in stiffness need not necessarily be accompanied by a change in temperature.

Further provided are methods, comprising with a flexible membrane, the flexible membrane capable of reversible conversion between a first state and a second state, optionally by application of heat to heat the membrane above a threshold temperature, the membrane in the first state having a first modulus that is higher than a second modulus of the membrane in the second state, contacting the flexible membrane in the second state to a first target object; and effecting adhesion between the flexible membrane and the first target object, optionally by placing the flexible membrane at a temperature below the threshold temperature.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1. Overview of the shape memory polymer (SMP) adhesive end effector. (A) Schematic of the end effector showing the SMP membrane, support chamber and heater. (B) A picture of the SMP adhesive end effector viewed from the membrane side. (C) Principle of operation of the SMP end effector for picking up and releasing an object. (D) A typical load vs. time curve shown for the SMP end effector picking and releasing a 161 g PMMA sheet. The end effector in its rest state (I) was first heated to 70° C. and contacted the object with a preload of 5 N (II); after waiting for 10 s, the heater was turned off, and an air pump was turned on for 120 s to convectively cool the SMP membrane and apply a 6.9 kPa pressure to the membrane (III); after the pump was turned off for 10 s, the object was picked up (IV) and held; then the heater was turned on again for 8 s and the object was released (V).

FIG. 2. Adhesion characterization of the shape memory polymer (SMP) adhesive gripper. (A) The measured pull-off force in the stiff-state (F_{c}) as a function of preload (Fₚᵣₑ) for tests on curved PMMA substrates with R_{b}=25.4, 12.7, 6.35 mm (open markers at Fₚᵣₑ=2 N are stiff-state pull-off forces measured with the SMP membrane cooled passively by the environment to reduce vibration during cooling) (error bar denotes standard deviation of three tests). (B) Measured soft-state pull-off force (Fᵣ) on curved PMMA substrates with R_{b}=25.4, 12.7, 6.35 mm (error bar denotes standard deviation of three tests).

FIG. 3. Use of pressure to enhance shape memory polymer (SMP) adhesive end effector performance. (A) Measured stiff-state pull-off forces (F_{c}) on a flat PMMA substrate for different operation procedures: Press: (i) the SMP membrane is heated to the soft state and displaced against the substrate to form contact with no pressure applied in the chamber, (ii) cooled to the stiff state and pulled off; 6.9 kPa preload: (i) the SMP membrane is heated to the soft state and displaced against the substrate to form contact, (ii) 6.9 kPa pressure is applied inside the chamber to improve the contact between the membrane and surface, (iii) cooled to the stiff state and pulled off after removing the 6.9 kPa pressure; −6.9 kPa pull-off: (i) the SMP membrane is heated to the soft state and displaced against the substrate to form contact, (ii) 6.9 kPa pressure is applied inside the chamber to enhance contact, (iii) cooled to the stiff state and pulled off with the −6.9 kPa pressure maintained inside the chamber (error bar denotes standard deviation of three tests). (B) Measured soft-state pull-off force (Fᵣ) on a flat PMMA substrate with different pressures inside the chamber (error bar denotes standard deviation of three tests). (C) Adhesion switching ratio (F_{c}/Fᵣ) on a flat PMMA substrate as a function of the stiff-state pull-off test operation procedures (“Press”, “6.9 kPa preload” and “−6.9 kPa pull-off” shown in FIG. 3A) and the applied pressure during soft-state pull-off test (shown in FIG. 3B).

FIG. 4. Examples of the shape memory polymer (SMP) adhesive gripper gripping various objects. (A) A 105-g Rubik's Cube™. (B) A 150-g apple. (C) A 4-g pen. (D) An array of twenty-four individual 6.35 mm dia. 0.16-g plastic beads. (E) A 116-g plastic dome with a radius of curvature of 90 mm. (F) A 10-g silicon wafer. (G) A 14-g double concave lens with diameter 50 mm and focal length 200 mm. (H) A 61-g PDMS block.

FIG. 5. Measured pull-off forces as a function of pull-off speed. (A) Measured stiff-state pull-off forces (F_{c}) as a function of pull-off speed on a curved substrate with R_{b}=25.4 mm with 5 N preload (error bar denotes standard deviation of three tests). (B) Measured soft-state pull-off forces (Fᵣ) as a function of pull-off speed on a curved substrate with R_{b}=25.4 mm with a 5 N preload (error bar denotes standard deviation of three tests).

FIG. 6. Schematics of the analytical model for the gripper in different modes. (A) Schematic of the unstructured membrane in contact with a curved substrate in soft state. (B) Schematic of the unstructured membrane being pulled-off from a curved substrate in the stiff state. (C) Schematic of the gripper being pulled-off from a curved substrate in the soft state.

FIG. 7. Calculated contact area on curved substrates in the soft state. (A) Calculated contact area as a function of preload (Fₚᵣₑ) on curved substrates with R_{b}=25.4, 12.7, 6.35 mm. (B) Calculated contact area as a function of membrane thickness (h) on curved substrates with R_{b}=25.4, 12.7, 6.35 mm. (C) Calculated contact area as a function of soft state modulus (Eᵣ) on curved substrates with R_{b}=25.4, 12.7, 6.35 mm.

FIG. 8. Calculated stiff-state pull-off force (F_{c}) on curved substrates. (A) Calculated stiff-state pull-off forces (F_{c}) as a function of preload (Fₚᵣₑ) on curved substrates with R_{b}=25.4, 12.7, 6.35 mm. (B) Calculated stiff-state pull-off forces (F_{c}) as a function of membrane thickness (h) on curved substrates with R_{b}=25.4, 12.7, 6.35 mm. (C) Calculated stiff-state pull-off forces (Eᵣ) as a function of soft state modulus (Eᵣ) on curved substrates with R_{b}=25.4, 12.7, 6.35 mm keeping modulus switching ratio (F_{c}/Eᵣ) at 333.3. (D) Calculated stiff-state pull-off forces (F_{c}) as a function of modulus switching ratio (F_{c}/Eᵣ) on curved substrates with R_{b}=25.4, 12.7, 6.35 mm keeping stiff state modulus (F_{c}) at 2.1 GPa. (E) Calculated stiff-state pull-off forces (F_{c}) as a function of work of adhesion (G_{c}) on curved substrates with R_{b}=25.4, 12.7, 6.35 mm.

FIG. 9. Calculated soft-state pull-off force (Fᵣ) on curved substrates. (A) Calculated soft-state pull-off forces (Fᵣ) as a function of preload (Fₚᵣₑ) on curved substrates with R_{b}=25.4, 12.7, 6.35 mm. (B) Calculated soft-state pull-off forces (Fᵣ) as a function of membrane thickness (h) on curved substrates with R_{b}=25.4, 12.7, 6.35 mm. (C) Calculated soft-state pull-off forces (Fᵣ) as a function of soft state modulus (Eᵣ) on curved substrates with R_{b}=25.4, 12.7, 6.35 mm. (D) Calculated soft-state pull-off forces (Fᵣ) as a function of work of adhesion (G_{c}) on curved substrates with R_{b}=25.4, 12.7, 6.35 mm.

FIG. 10. Picture of the adhesion test setup.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated+10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### Results and Discussion

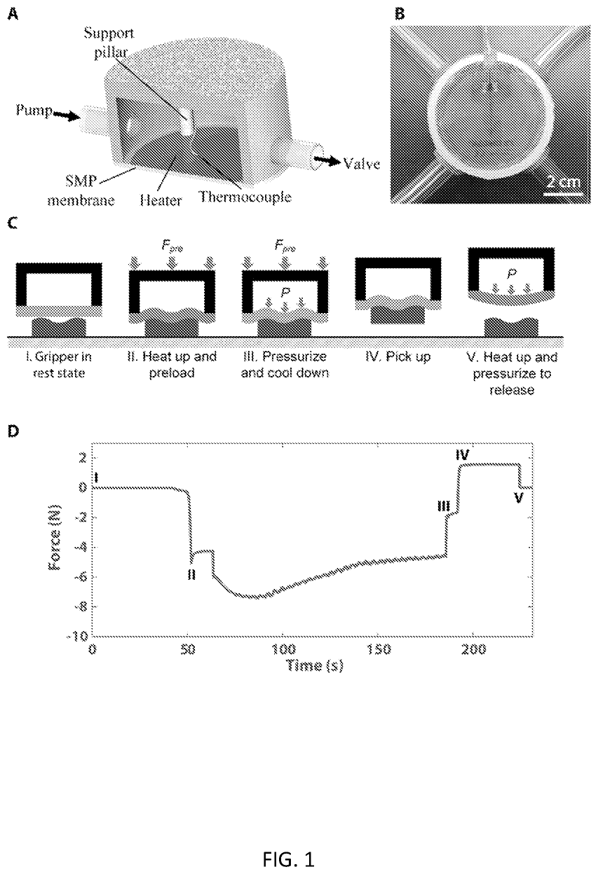

Design of the gripper. FIG. 1A shows the design of the SMP adhesive gripper. An unstructured flat SMP membrane is supported on a rigid chamber (internal radius of 28 mm), which is connected to a system that controls the pressure and flow of air through the chamber. A flexible heater (radius 22.5 mm) supported by compliant pillars is in contact with the SMP membrane and a thermocouple attached to the heater is used for measurement and control of the temperature. The unstructured flat SMP membrane is 1.6 mm thick and is made of a thermally responsive SMP (two-part epoxy, EPON 826 resin, Hexion, and Jeffamine D230 (poly (propylene glycol) bis(2-aminopropyl) ether curing agent, Huntsman Corp.) with a transition temperature of 72-60° C. When heated sufficiently above the transition temperature (7>70° C.), the SMP softens and the modulus is Eᵣ=6.3 MPa. When sufficiently below the transition temperature (approximately T≤40° C.), the SMP is in its stiff state with E_{c}=2.1 GPa. If held in a deformed state while cooling, the deformed shape is locked in after the membrane is cooled below the transition temperature. This SMP has an excellent ability to both retain the deformed temporary shape after cooling and to recover the original permanent shape after being reheated above the transition temperature. The transition temperature can be tuned through the SMP formulation (i.e. mixing ratio of the epoxy monomer and the curing agent) and 72-60° C. was chosen to avoid unintended actuation as it is higher than the temperatures of typical use environments but also sufficiently low to allow for relatively fast heating to the transition temperature. A picture of the gripper (FIG. 1B) shows the transparent unstructured flat SMP membrane bonded to an aluminum chamber and a flexible polyimide heater in contact with the backside of the membrane. Four tubes are connected to the chamber, two of which are connected to a pump and the other two are connected to valves that vent to atmosphere when open. A total of four ports, rather than the minimum of two, are used to provide a more uniform airflow over the SMP membrane during cooling to enhance convection.

Principle of operation. FIG. 1C illustrates the principle of operation of the SMP adhesive gripper and FIG. 1D shows a typical load vs. time curve for pick-and-place of a 161-g PMMA sheet. When not heated, the SMP membrane is stiff and cannot easily make conformal contact with other surfaces (FIG. 1C, I), thus preventing unintentional adhesion. During use, the SMP membrane is heated to 70° C. to soften the SMP, which takes 29 s, and then the membrane is contacted to the object (FIG. 1C, II). The contact is formed by displacing the chamber supporting the SMP membrane to bring the membrane into contact with the object. Additionally, in some cases, such as for contacting non-convex objects, the chamber can be pressurized to apply a preload over the entire membrane. While maintaining the contact, the SMP membrane is cooled to 30° C. by turning the heater off and flowing air through the chamber which takes 89 s (FIG. 1C, III). Upon cooling and stiffening, higher load capacity is realized, allowing gripping of various objects (FIG. 1C, IV). Importantly and non-obviously, no power is needed for the gripper to maintain this gripping state. Objects are released through heating and softening of the SMP membrane (FIG. 1C, V). The load capacity decreases with softening of the membrane and detachment is also facilitated by the tendency for the SMP to return to its original shape when heated. Pressure can also be applied during the release process to deform the contact and further reduce the adhesion.

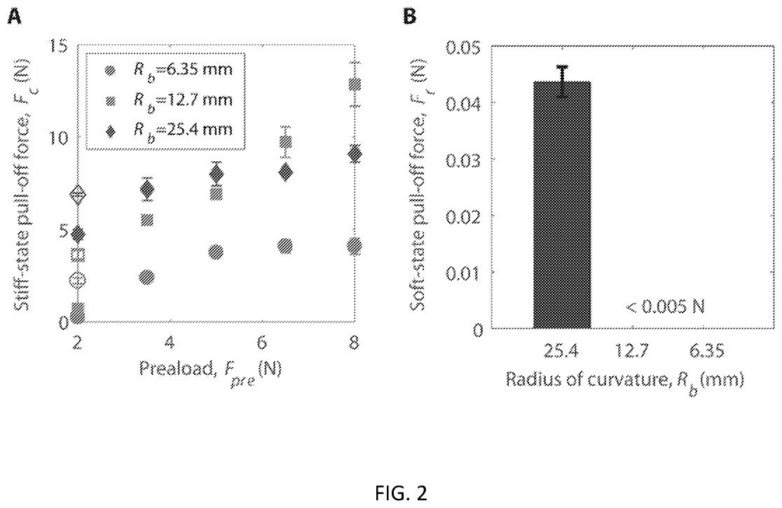

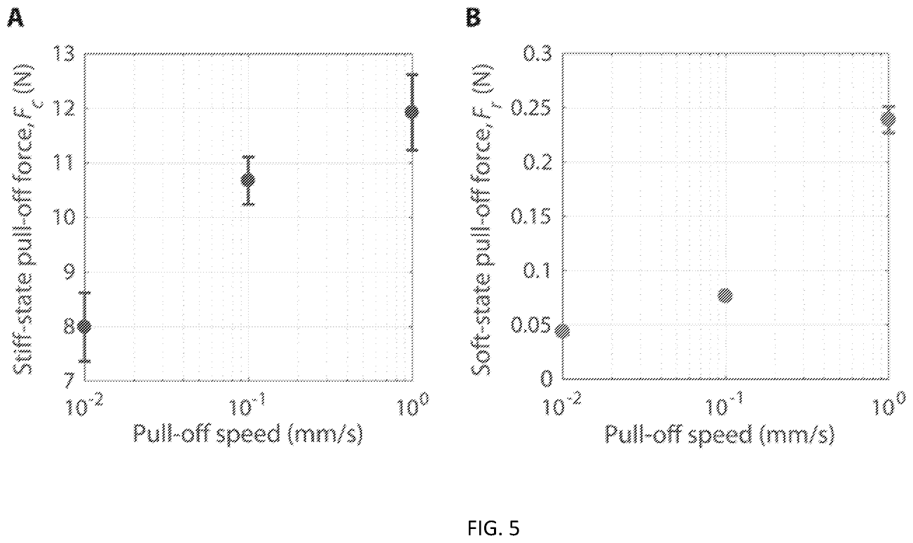

Adhesion characterization. The ability of an adhesion-based gripper to pick up an object depends on its adhesive force capacity and this is characterized by measuring the pull-off force of the gripper with the SMP in the stiff state. Measurements were performed against curved Polymethyl methacrylate (PMMA) substrates with three different radius of curvatures, Rh. The stiff-state pull-off test was conducted by first heating the SMP membrane to its soft state and bringing the membrane into contact with the substrate at a given preload, then cooling to 30° C. to stiffen the membrane, and subsequently displacing the gripper away from the substrate at 0.01 mm/s until pull-off occurs. The slow displacement rate is used to minimize the effect of viscoelasticity (for reference, the effect of the displacement rate on the stiff-state pull-off force is shown in FIG. 5A). The maximum force measured during the pull-off process is denoted as the stiff-state force capacity, F_{c}. The measured stiff-state force capacity as a function of preload and substrate curvature is shown in FIG. 2A. Higher adhesion was achieved with higher preload for all the curved substrates tested—this is different from conventional dry adhesives comprised of materials with no shape memory effect where the adhesion reaches a plateau at a critical preload value. For a material without the shape memory effect, increasing the preload increases the contact area but it also increases the stored elastic energy that counteracts adhesion. However, in the case of the SMP, the deformed shape in the preload step is locked in after cooling and the contact area is maintained. As a result, the adhesive force capacity increases with increasing preload when gripping a 3D object such as a curved substrate. Based on the same argument, the SMP is expected to maintain higher adhesion performance compared to other adhesives made of materials that have comparable soft state modulus but without shape memory effect when the surfaces are slightly damaged (e.g., scratched). This is because a slightly damaged SMP surface can still be heated and preloaded to achieve contact with the object and fix the contact after cooling, while a slightly damaged non-shape memory material surface that is preloaded into contact with an object will have increased elastic energy penalty.

Generally, for a given preload, higher adhesion is expected on substrates that are flatter, i.e. substrates with larger radius of curvatures. This trend holds for the SMP gripper when the preload is small (Fₚᵣₑ≤5N), however, for larger preload (Fₚᵣₑ>5N) the adhesion on a curved substrate with R_{b}=12.7 mm is higher than that on a curved substrate with R_{b}=25.4 mm (FIG. 2A). The underperformance of the SMP adhesive gripper on the curved substrate with R_{b}=25.4 mm at a large preload is believed to be caused by nonuniform heating of the SMP membrane. The heater has an effective heating radius of 22.5 mm, so it is expected that only the center portion of the SMP membrane is heated sufficiently to its soft state to make conformal contact. As a result, the contact area and the adhesion achieved at a high preload on the curved substrate with R_{b}-25.4 mm may be smaller compared to the case where the membrane is uniformly heated throughout. It was observed that for small preloads (Fₚᵣₑ=2 N), the oscillation of the airflow generated by the pump during cooling can deteriorate the quality of the contact and reduce the adhesion. The adhesion in the absence of vibration of the membrane was characterized by cooling the SMP membrane passively by the environment and the corresponding pull-off forces are included as open markers in FIG. 2A. The absence of vibration during cooling increases the adhesion at small preloads for all the curved substrates tested, but there is no discernible difference in the adhesion obtained between the two cases when the preload is larger (Fₚᵣₑ>2 N). This could potentially be an issue for pick-and-place of fragile objects where only a small preload can be applied but could be overcome by improving the uniformity of the flow, for example, by using a compressed air reservoir or a fan rather than a mechanical pump.

A successful pick-and-place operation also requires the ability to release objects. The performance of the gripper on this metric is characterized using soft-state pull-off tests against the same curved PMMA substrates. In the soft-state pull-off tests, the SMP membrane is heated up to its soft state and brought into contact with the substrate, then pulled off at a speed of 0.01 mm/s while the temperature is maintained (effect of the pull-off speed on the soft-state pull-off force is shown in FIG. 5B). The measured soft-state pull-off force Fᵣ, which is the maximum force obtained during the soft-state pull-off process, quantitatively describes the ability of the SMP adhesive gripper to release an object and a smaller force is more favorable. The soft-state pull-off forces, shown in FIG. 2B, are independent of preload. The soft-state pull-off force is ˜0.045 N on the curved substrate with R_{b}=25.4 mm and is <0.005 N (which is smaller than the noise floor of the force sensor) on the curved substrates with R_{b}=12.7 mm and 6.35 mm. Thus, the adhesion switching ratio (the ratio of the stiff-state pull-off force to the soft-state pull-off force) is ˜200 on R_{b}=25.4 mm substrate and >2000 and >600 on the R_{b}=12.7 mm and 6.35 mm substrates, respectively.

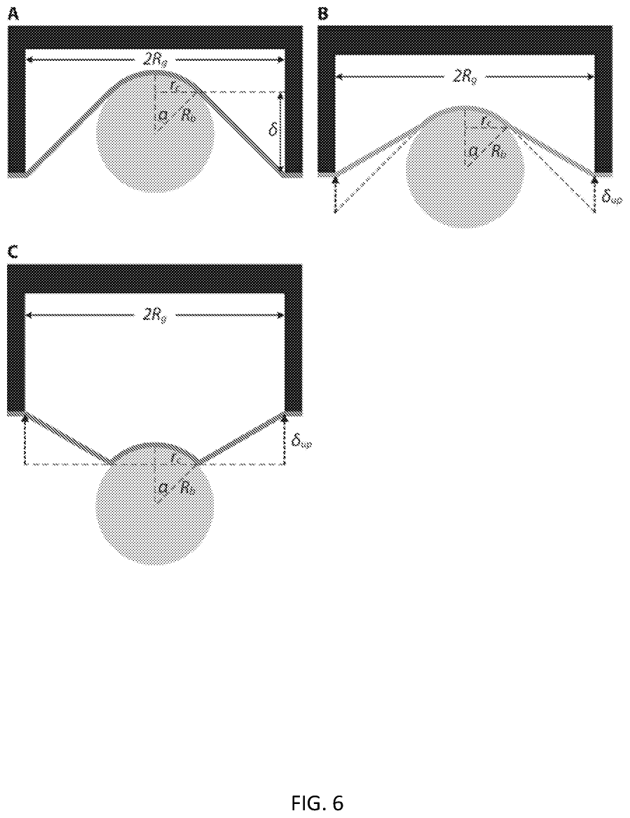

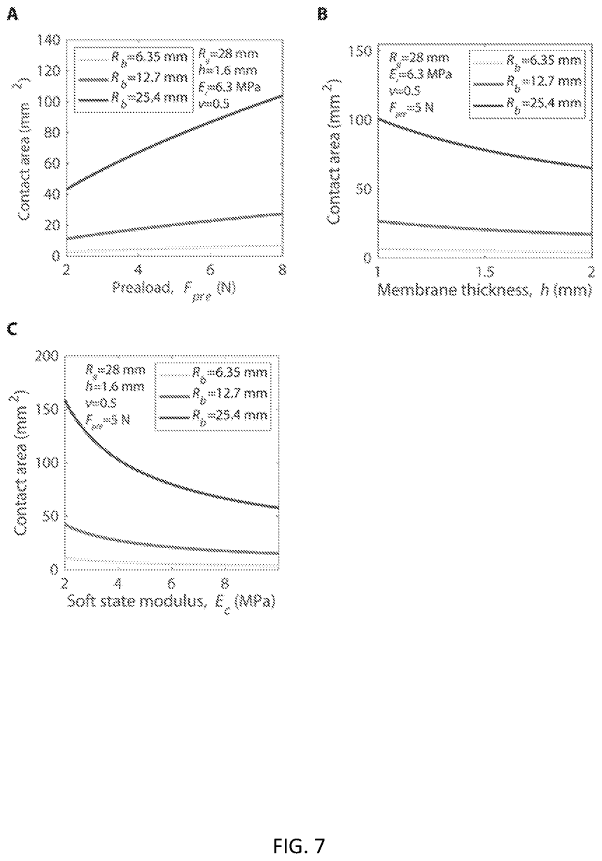

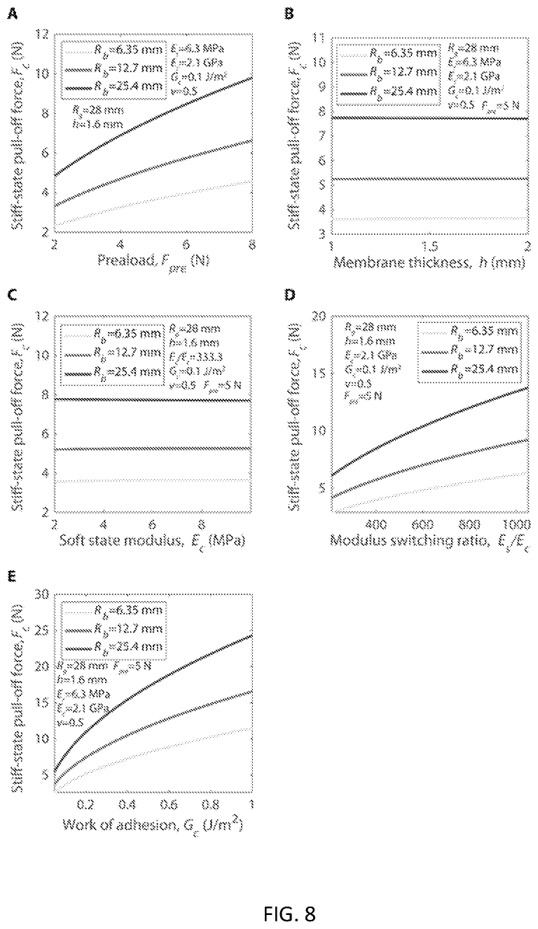

Analytical modeling. To understand the effect of different design parameters, notably geometry and material properties, on the adhesion of the device, a simple analytical membrane model (which ignores bending deformation) that estimates the adhesion of the device to a curved substrate was developed. The model is based on idealized assumptions that are not fully satisfied in the experiment: The SMP is uniformly heated to its soft state and completely recovers the original permanent shape after being heated to the soft state; it completely fixes the deformed temporary shape after being cooled to the stiff state. Details of the model are presented in the Supporting material (FIG. 6) and the results are summarized in FIGS. 7-9. From FIG. 8, the calculated stiff-state pull-off force on a curved substrate using this model is found to scale with the square root of the preload Fₚᵣₑ, work of adhesion G_{c}, modulus switching ratio E_{c}/Eᵣ and radius of curvature of the substrate R_{b} over the range of parameters investigated:

$${F}_{c} ∝ \sqrt{{F}_{p r e} {G}_{c} \frac{{E}_{c}}{{E}_{r}} {R}_{b}} . \qquad ( 1 )$$

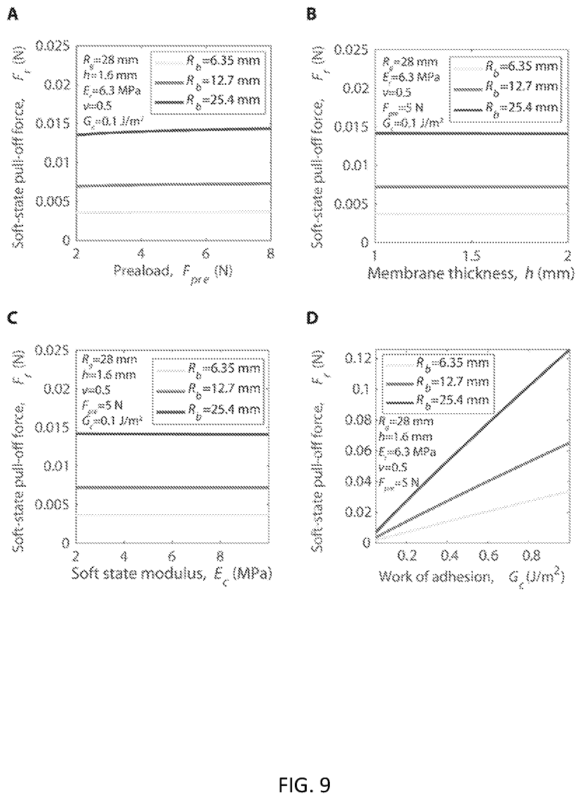

The calculated stiff-state pull-off force is positively correlated to the modulus switching ratio E_{c}/Eᵣ because of two effects: (1) a higher stiff-state modulus F_{c} leads to a higher stiff-state pull-off force because it reduces system compliance, (2) a lower soft-state modulus Eᵣ increases the contact radius achieved during the preload step. Membrane thickness h is absent from eq. (1) because while a larger membrane thickness reduces compliance and increases the stiff-state pull-off force, the larger membrane thickness also reduces the contact radius achieved during preloading. The pull-off force on a curved substrate in the soft state is found to scale with the work of adhesion Ge and radius of curvature of the substrate R as shown in FIG. 9, and is relatively insensitive to other parameters in the range investigated:

$${F}_{r} ∝ {G}_{c} {R}_{b} . \qquad ( 2 )$$

The soft-state pull-off force is insensitive to membrane thickness h and soft-state modulus Eᵣ. A larger membrane thickness h or a larger soft-state modulus Eᵣ leads to a higher membrane stiffness. While a higher membrane stiffness improves the loading sharing, it also increases the elastic energy penalty when conforming to a non-planar surface.

While both the calculated stiff-state and soft-state pull-off forces are not affected by the thickness of the membrane h and the soft-state modulus Eᵣ (for a fixed modulus switching ratio/c/Eᵣ), thinner membranes and materials with lower soft state modulus Ær result in more compliant membranes in the soft state and thus can achieve larger contact areas. Within the assumptions of the model, a larger contact area is predicted during the preload step, FIG. 7, which improves gripping stability (e.g., improved ability to resist moments applied to the contact and off-axis loads). Beyond the membrane-level deformations considered in the model, a lower stiffness membrane also allows better local conformal contact. This results in an improved ability to grasp objects with complex geometries and also may yield higher effective G_{c} through improved accommodation of roughness.

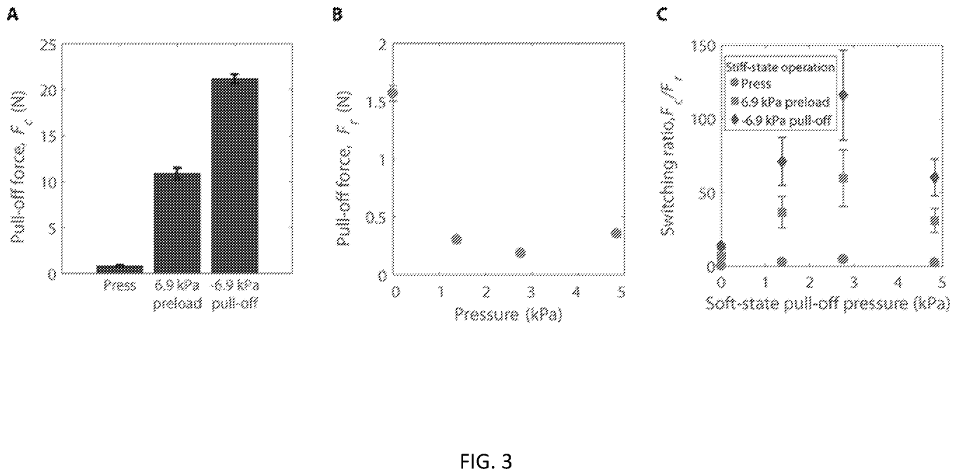

Effect of pressure on adhesion. Application of pressure inside the chamber in different steps of the operation provides the opportunity to enhance the performance of the gripper. Application of a positive pressure during the preload step can improve the contact area, while applying a negative pressure during the stiff-state pull-off step can increase the load capacity. Furthermore, maintaining a positive pressure during the soft-state pull-off step can reduce the adhesion and allow for object release at lower loads. These benefits are demonstrated through pull-off tests against a flat PMMA substrate. If the preload step is conducted simply by displacing the SMP membrane against the flat substrate, the compressive preload is primarily concentrated around the edge of the SMP membrane through the chamber wall, leaving the central region of the membrane largely unloaded. This nonuniform preload, as well as possible misalignment and surface roughness of both surfaces, limits contact of the membrane and leads to a stiff-state pull-off force of only 0.9 N for a flat substrate (denoted as “Press” in FIG. 3A). However, a positive pressure applied after the membrane is displaced to contact the substrate during the preload step results in in better contact across the full SMP membrane, for example, application of 6.9 kPa pressure in the preload step increases the stiff-state pull-off force to 10.9 N (denoted as “6.9 kPa preload” in FIG. 3A). The application of a positive pressure during preload is especially beneficial for achieving large contact area to non-convex objects. Moreover, a negative pressure can be applied during the stiff-state pull-off step to increase the load capacity. After the contact was formed by applying 6.9 kPa pressure in the preload step, the membrane was cooled to its stiff state and then pulled off with a negative pressure of magnitude 6.9 kPa. The negative pressure resulted in a load capacity of 21.2 N (“−6.9 kPa pull-off” data in FIG. 3A). The increased load capacity due to the applied negative pressure is primarily due to improved load sharing across the membrane. Additionally, there is a potential contribution to the adhesion from suction

Finally, we demonstrate that soft-state pull-off force can be decreased through application of a positive pressure during release. A decrease in pull-off force with positive pressure is expected for the blister configuration. In a soft-state pull-off test against the flat substrate, the same contact as that in the stiff-state pull-off test was first generated by applying 6.9 kPa pressure in the preload step, then different positive pressures were applied during the soft-state pull-off step to investigate the effect of pressure on the soft-state pull-off force. The results, summarized in FIG. 3B, show that the soft state adhesion is significantly reduced when a positive pressure is applied. While the adhesion is expected to monotonically reduce with increasing pressure for a blister configuration, the pull-off force observed in experiments increased slightly at the highest pressure (4.8 kPa in FIG. 3B). This is likely due to the membrane being deformed farther from the heater at high applied pressures resulting in some cooling and hence stiffening of the membrane. FIG. 3C summarizes the adhesion switching ratio (F_{c}/Fᵣ) on the flat substrate as a function of the stiff-state pull-off test operation procedures (operation procedures “Press”, “6.9 kPa preload” and “−6.9 kPa pull-off” are described above and in the caption of FIG. 3, and the corresponding data are shown in FIG. 3A) and the applied pressure during soft-state pull-off test (data shown in FIG. 3B) and a maximum adhesion switching ratio ˜115 is achieved on a flat substrate.

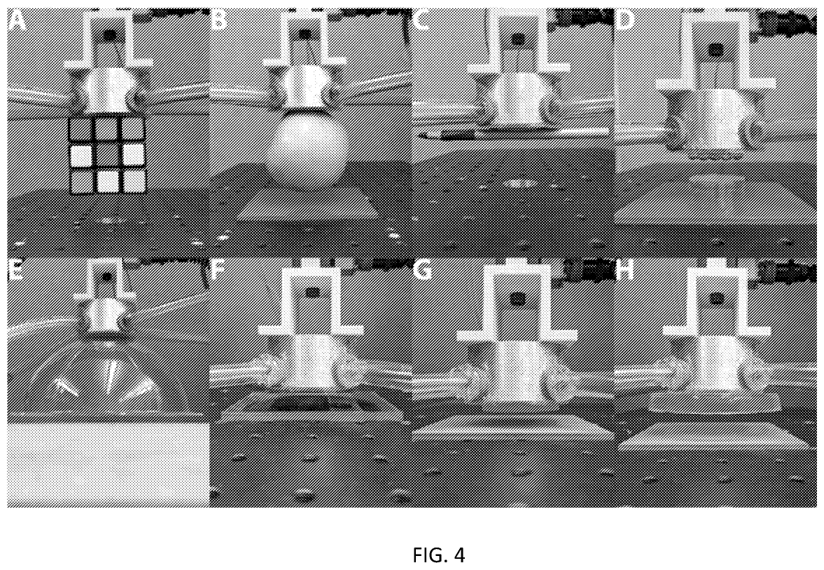

Demonstrations. Finally, to demonstrate the gripping ability of the SMP adhesive gripper, the use of the SMP adhesive gripper to grip various 3D objects, including convex objects (B, C, D, E in FIG. 4), flat objects (A, F in FIG. 4), an concave object (G in FIG. 4) and a deformable object (H in FIG. 4), is highlighted in FIG. 4 (syringe pump was used to pressurize the contact with the double concave lens to avoid fluctuation created by the air pump (FIG. 4G)). All the objects are easily released when the SMP membrane is heated (6.9 kPa pressure was applied in addition to heating to facilitate the release of the 0.16 plastic beads (FIG. 4D)).

### CONCLUSION

We have demonstrated and characterized a SMP adhesive gripper that exploits variable stiffness to controllably pick-and-place 3D objects. This device is comprised of an unstructured variable stiffness SMP membrane bonded to a chamber that can be pressurized. The SMP membrane is heated to its soft state and conforms to the object upon contact under preload. Upon cooling to its stiff state, the contact area achieved during preloading is maintained while the adhesive load capacity is increased due to the increased modulus of the SMP. Note that in the stiff, high-adhesion state, the SMP is not heated and thus no power is needed to maintain the attachment.

Objects are released by heating the membrane to its soft state, which allows the interface to detach at comparatively low loads. The SMP adhesive gripper was demonstrated to have a load capacity of ˜13 N and a switching ratio of >2000 on a curved substrate with a radius of curvature 25.4 mm, and a load capacity of ˜21 N and a switching ratio of ˜115 on a flat substrate. The ability to pressurize the chamber allows a preload to be applied across the membrane surface to make contact to flat and concave surfaces. Furthermore, pressurization can be used to increase the load capacity and facilitate release. While friction-based grippers cannot pick up planar objects and most dry adhesives only work well on planar objects, the adhesion-based gripper proposed here can grip a variety of 3D objects.

### Materials and Methods

### Fabrication of the SMP Adhesive Gripper

A cylindrical chamber with a 25.4 mm depth, 31.8 mm outer radius, and 28 mm inner radius was machined out of aluminum. The chamber has four 9.5 mm diameter holes, spaced 90° apart in the sidewall of the chamber for the air inlets and outlets and an additional 6.4 mm diameter hole for the heater and the thermocouple wires. A thermocouple (SA1XL-K-72, Omega Engineering) was bonded to the backside of a 25.4 mm-radius 31-Watt circular flexible polyimide heater (KHRA-2/10, Omega Engineering) using silicone sealant (8661 Super Silicone Sealant, 3M). The heater and the thermocouple were connected to a PID controller (CN32PT-330, Omega Engineering) to monitor and control the temperature. Four silicone foam pillars with height 25.4 mm and diameter 5 mm (McMaster-Carr) were bonded to the top of the chamber and the heater was bonded to these pillars. The gap around the heater and thermocouple wires was sealed with silicone. Four flexible tubes were connected to the chamber. Two of the tubes were connected to valves to regulate the pressure within and airflow through the chamber, and the other two tubes were connected to an air pump (102 W 6624.5 L/hr flow rate, VIVOHOME, Amazon) or a syringe pump (Pump 11 Elite, Harvard Apparatus) depending on the required pressure. The unstructured flat SMP membrane was bonded to the open side of the chamber with the silicone sealant.

### Adhesion Tests

The SMP adhesive gripper was attached to a mounting block and then fixed in a standard universal testing machine (MTS Criterion Model 43) fitted with a 50 N load cell (MTS LSB.501).

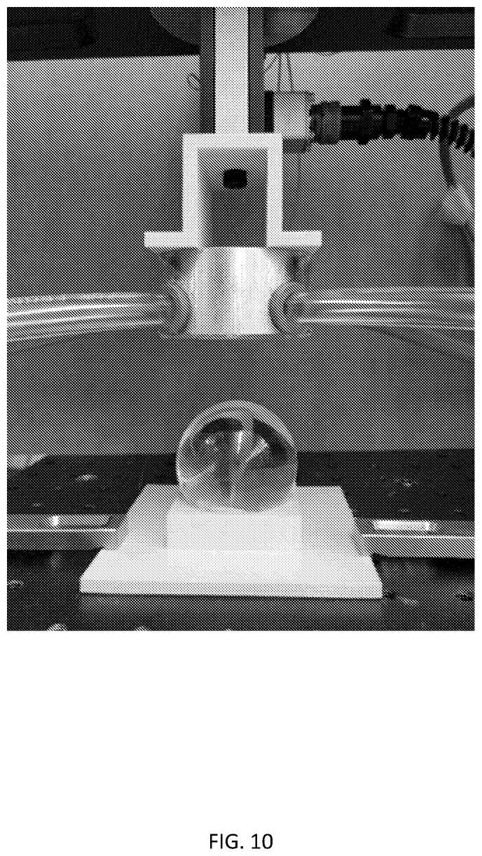

Stiff-state pull-off test. The curved testing substrates were PMMA balls (TAP Plastics) with radii of 6.35, 12.7 and 25.4 mm. The balls were glued to holders and fixed in the testing machine. A picture of the adhesion test setup is shown in FIG. 10. In a stiff-state pull-off test, the SMP membrane was brought into contact with the curved substrate at 70° C. at a rate of 0.2 mm/s to a prescribed preload (varied from 2 to 8 N). After stabilizing the contact for another 10 s, the heater was turned off and the pump was turned on for 4 min to cool the device. To eliminate the minor temperature increase due to the heat generated by the pump, the device was also allowed to sit for another 4 min. In the cases where the SMP membrane was cooled passively by the environment (unfilled markers at Fₚᵣₑ=2 N in FIG. 2A), the device was simply allowed to sit for 10 min after the heater was turned off. After cooling, the device was pulled-off at a rate of 0.01 mm/s. The maximum force recorded during pull-off in each test is denoted as the stiff-state pull-off force. Stiff-state pull-off test against a flat substrate was conducted in similar way and is detailed in Supplementary material.

Soft-state pull-off test. In the soft-state pull-off tests against a curved substrate, the membrane was kept at 70° C. using the controller throughout the test. The SMP membrane was brought into contact with the curved substrate at a rate of 0.2 mm/s to a preload of 5 N. After stabilizing the contact for another 10 s, the device was pulled-off at a rate of 0.01 mm/s. The maximum force recorded in the pull-off step in each test is denoted as the soft-state pull-off force. Soft-state pull-off test against a flat substrate was conducted in similar way.

### Effect of Pull-Off Speed on Adhesion

Stiff and soft-state pull-off tests were conducted at different pull-off speeds on a curved substwrate with R_{b}=25.4 mm with a 5 N preload to investigate the effect of pull-off speed on adhesion and the corresponding results are summarized elsewhere herein. Higher pull-off speed results in higher pull-off force in both the stiff-state pull-off tests and the soft-state pull-off tests. This trend agrees with the trend commonly observed for dry adhesives⁴², and shows that the pull-off speed has a substantial effect on the performance of the SMP adhesive gripper.

### Analytical Estimation of the Effect of Design Parameters

An analytical model was developed to estimate the effect of different design parameters. The model only considers the membrane deformation of the SMP membrane and neglects its bending deformation (this is a reasonable approximation for a thin membrane studied in this paper, though its bending stiffness is not zero in reality). The SMP is assumed to be an incompressible linear elastic material and have the same work of adhesion in both the soft and the stiff states. The SMP is assumed to be uniformly heated and completely recovers the original permanent shape after being heated to the soft state and removing the constraints (this assumption is not fully satisfied in our experiments primarily because the SMP membrane was not uniformly heated due to limited size of the heater and contact resistance), and completely fixes the deformed temporary shape after being cooled to the stiff state and removing the constraints (this assumption is also not fully satisfied because the shape memory polymer will not perfectly fix the temporary shape due to effect such as thermal contraction when cooled down). The shape of the deformed SMP membrane outside of the contact area in both the preload and pull-off processes is assumed to be a truncated cone as shown elsewhere herein. The parameters used in the model calculations are summarized in Table 1 below:

TABLE 1
Parameters used in the model

| Chamber inner radius, R_{g} | 28.0 | mm |
|---|---|---|
| Membrane thickness, h | 1.6 | mm |
| Radius of curvature of | 25.4, 12.7, 6.35 | mm |
| substrate, R_{b} | | |
| Soft state modulus, Eᵣ | 6.3 | MPa |
| Stiff state modulus, E_{c} | 2.1 | GPa |
| Poisson's ratio, ν | 0.5 | |
| Work of adhesion, G_{c} | 0.1 | J/m² |

| | |
|---|---|
| Preload, Fₚᵣₑ | 5N |

In the preload step, the whole SMP membrane is assumed to be in its soft state and is displaced against the substrate to a given preload as shown in A. A contact with angle α, which corresponds to contact radius r_{c}=R_{b} sinα, is formed in this preload step. Assuming the membrane deforms into a truncated cone, the radial strain Eᵣ, circumferential strain ε_{ϕ} and through thickness strain ϕ_{z} are⁴³:

$${ε}_{r} = \frac{1}{cos α} = \frac{\sqrt{{( {R}_{g} - {r}_{c} )}^{2} + {δ}^{2}} - ( {R}_{g} - {r}_{c} )}{{R}_{g} - {r}_{c}} {ε}_{ϕ} = 0 {ε}_{z} = \frac{1}{{ε}_{r}} = cos α = \frac{{R}_{g} - {r}_{c}}{\sqrt{{( {R}_{g} - {r}_{c} )}^{2} + {δ}^{2}} - ( {R}_{g} - {r}_{c} )} . \qquad ( S3 )$$

The strain energy of the deformed membrane U is:

$$U = \frac{2}{3} {E}_{r} {ε}_{r}^{2} π ( {R}_{g}^{2} - {r}_{c}^{2} ) h . \qquad ( S4 )$$

where Eᵣ is the modulus of the membrane in the soft state, R_{g} is the inner radius of the chamber, h is the thickness of the membrane. According to conservation of energy, the force Fₚᵣₑ can be calculated by:

$${F}_{pre} = \frac{\partial U}{\partial δ} {\vert}_{{r}_{c} , δ} . \qquad ( S 5 )$$

shows the calculated contact area in the preload step for various parameters. As expected, contact area in the preload step increases as the preload increases and the stiffness of the membrane decreases (i.e. thickness of the membrane decreases, soft state modulus decreases).

In the stiff-state pull-off step, the undeformed shape of the SMP membrane in this step is assumed to be the shape from the preload step and the whole SMP membrane is assumed to be in its stiff state. The membrane is displaced up vertically as shown. The radial strain εᵣ, circumferential strain ε_{g} and through thickness strain ε_{z} in the stiff-state pull-off step are:

$${ε}_{r} = \frac{\sqrt{{( {R}_{g} - {r}_{c} )}^{2} + {( δ - {δ}_{up} )}^{2}} - \sqrt{{( {R}_{g} - {r}_{c} )}^{2} + {δ}^{2}}}{\sqrt{{( {R}_{g} - {r}_{c} )}^{2} + {δ}^{2}}} {ε}_{ϕ} = 0 {ε}_{z} = \frac{1}{{ε}_{r}} = \frac{\sqrt{{( {R}_{g} - {r}_{c} )}^{2} + {δ}^{2}}}{\sqrt{{( {R}_{g} - {r}_{c} )}^{2} + {( δ - {δ}_{up} )}^{2}} - \sqrt{{( {R}_{g} - {r}_{c} )}^{2} + {δ}^{2}}} . \qquad ( S6 )$$

The strain energy of the membrane U is⁴⁵:

$$U = \frac{2}{3} {E}_{c} {ε}_{r}^{2} π ( {R}_{g}^{2} - {r}_{c}^{2} ) h . \qquad ( S7 )$$

where E_{c} is the stiff state modulus.

Since the pull-off process in the stiff state occurs under small strains and the crack was observed to propagate unstably after initiation, the delamination can be analyzed in a manner similar to brittle fracture and the stiff-state pull-off force F_{c} is reached at the initiation of the crack. According to Griffith criterion, the critical displacement δ*ᵤₚ satisfies⁴⁶:

$$\frac{\partial U}{\partial A} {\vert}_{{r}_{c} , {δ}_{up}^{*}} = - \frac{1}{2 π {R}_{b}^{2} sin α} \frac{\partial U}{\partial α} {\vert}_{α , {δ}_{up}^{*}} = {G}_{c} . \qquad ( S8 )$$

where A is the contact area, G_{c} is the work of adhesion. The stiff-state pull-off force F_{c} can then be calculated by

$${F}_{c} = \frac{\partial U}{\partial {δ}_{up}} {\vert}_{{r}_{c} , {δ}_{up}^{*}} . \qquad ( S9 )$$

shows the calculated stiff-state pull-off force for various parameters. It is found that the stiff-state pull-off force increases as the preload Fₚᵣₑ increases, work of adhesion G_{c} increases and the modulus switching ratio E_{c}/Eᵣ increases, while it is nearly independent of the membrane thickness h, and value of the modulus in soft state Eᵣ and stiff state E_{c} given a preload. Through fitting of the calculated results, we find

$${F}_{c} ∝ {r}_{c}^{\frac{3}{2}} \sqrt{{G}_{c} {E}_{c} h {R}_{b}} , \qquad ( S10 )$$

$${r}_{c} ∝ {F}_{pre}^{\frac{1}{3}} {E}_{r}^{\frac{1}{3}} {h}^{\frac{1}{3}} . \qquad ( S11 )$$

The stiff-state pull-off force F_{c} is positively correlated to contact radius r_{c}, work of adhesion G_{c}, stiff state modulus E_{c} and membrane thickness h. However, contact radius r_{c} is positively correlated to preload Fₚᵣₑ while negatively correlated to soft state modulus Eᵣ and membrane thickness h. Substitution of eq. (S11) into eq. (S10), we obtain:

$${F}_{c} ∝ \sqrt{{F}_{pre} {G}_{c} \frac{{E}_{c}}{{E}_{r}} {R}_{b}} . \qquad ( S12 )$$

It is found that stiff-state pull-off force F_{c} scales with the square root of preload Fₚᵣₑ (an increase in the stiff-state pull-off force as a function of the preload was also observed in experiments (FIG. 2A)), work of adhesion G_{c}, the modulus switching ratio E_{c}/Eᵣ and radius of curvature of the substrate R_{b} in the range of the parameters investigated in this work.

In the soft-state pull-off step, the undeformed shape of the SMP membrane is assumed to be its original permanent shape (i.e. a flat membrane) and the whole SMP membrane is assumed to be in its soft state. The membrane is displaced vertically as shown in

C. The radial strain εᵣ, circumferential strain ε_{ϕ} and through thickness strain ε_{z} in the soft-state pull-off step are⁴³:

$${ε}_{r} = \frac{\sqrt{{( {R}_{g} - {r}_{c} )}^{2} + {δ}_{up}^{2}} - ( {R}_{g} - {r}_{c} )}{{R}_{g} - {r}_{c}} {ε}_{ϕ} = 0 {ε}_{z} = \frac{1}{{ε}_{r}} = \frac{{R}_{g} - {r}_{c}}{\sqrt{{( {R}_{g} - {r}_{c} )}^{2} + {δ}_{up}^{2}} - ( {R}_{g} - {r}_{c} )} . \qquad ( S13 )$$

The strain energy of the membrane U is⁴⁵:

$$U = \frac{2}{3} {E}_{r} {ε}_{r}^{2} π ( {R}_{g}^{2} - {r}_{c}^{2} ) h . \qquad ( S14 )$$

where Eᵣ is the soft state modulus.

According to Griffith criterion, the critical displacement satisfies

$$\frac{\partial U}{\partial A} {\vert}_{{r}_{c} , {δ}_{up}^{*}} = - \frac{1}{2 π {R}_{b}^{2} sin α} \frac{\partial U}{\partial α} {\vert}_{α , {δ}_{up}^{*}} = {G}_{c} . \qquad ( S15 )$$

Since the soft-state pull-off process behaves more like a peel test, it is possible that the soft-state pull-off force may not be achieved when the crack initiates. However, in the range of the parameters studied in this work, the soft-state pull-off force Fᵣ is always achieved the crack initially starts to propagate. The pull-off force Fᵣ can then be calculated by

$${F}_{r} = \frac{\partial U}{\partial {δ}_{up}} {\vert}_{{r}_{c} , {δ}_{up}^{*}} . \qquad ( S16 )$$

shows the calculated soft-state pull-off force for various parameters. The soft-state pull-off force is almost independent of all other parameters except the work of adhesion Ge and radius of curvature of the substrate R_{b}, and therefore:

$${F}_{r} ∝ {G}_{c} {R}_{b} . \qquad ( S17 )$$

This scaling is similar to what is seen in the common peel test, and the independence of the soft-state pull-force force as a function of the preload was observed in experiments (FIG. 2B). Based on eqs. (S12) and (S17), the switching ratio follows scaling relation:

$$\frac{{F}_{c}}{{F}_{r}} ∝ \sqrt{\frac{{F}_{pre} {E}_{c}}{{G}_{c} {E}_{r}}} . \qquad ( S18 )$$

### Adhesion Test Setup

A picture of the adhesion test setup is shown in FIG. 10. The SMP adhesive gripper was attached to a 3D printed mounting block and then fixed onto a load cell in the testing machine. The test substrate was a PMMA ball glued to a 3D printed holder, and the holder was fixed on the bottom substrate of the testing machine.

### Fabrication of the SMP Membrane

The shape memory polymer (SMP) is a two-part epoxy consisting of EPON 826 resin (Hexion) and Jeffamine D230 curing agent (poly (propylene glycol) bis(2-aminopropyl) ether, Huntsman). To obtain a SMP with a transition temperature of 60° C., the epoxy resin and the curing agent was mixed at a ratio of EPON 826: Jeffamine D230 of 1000:478 by weight. The two components were mixed thoroughly by hand and degassed for 5 min in vacuum. The degassed mixture was poured onto a polydimethylsiloxane (PDMS) coated glass plate (preparation described below). Another identical PDMS coated glass plate was placed on top and the spacing of the plates, and hence the thickness of the cast membrane, was controlled by placing 1.6 mm dia. steel balls between the plates as spacers. Before pouring the SMP mixture onto the glass plate, both glass plates were heated at 100° C. for at least 10 min to eliminate the potential outgassing during casting. The assemblies were placed on a hot plate and cured at 100° C. for 120 minutes. After curing, the fabricated unstructured flat SMP membrane was peeled off the plate and cut into a 31.8 mm radius circle using a pair of scissors.

The PDMS coating on the glass plate is needed to ensure that the SMP membrane can be released after casting. To prepare a PDMS-coated glass plate, PDMS (Sylgard 184, Dow Corning Corporation) with a 10:1 weight ratio of base elastomer to curing agent was mixed thoroughly by hand and degassed in a vacuum for 15 min. The PDMS mixture was then spin coated onto a 100 mm by 100 mm glass plate at 3000 rpm for 60 s to form a 30 μm thick film. The PDMS was cured on a hot plate at 85° C. for 90 min. Another PDMS coated glass plate was made in the same way.

### Stiff-State Pull-Off Test Against a Flat Substrate

In the pull-off tests against a flat substrate, the test substrate was a flat sheet of PMMA. The sheet was mounted on a self-aligning ball-and-socket tilt-stage (Thorlabs) to ensure alignment in the test. In the stiff-state pull-off tests, the SMP membrane was heated to 70° C. and then brought into contact with the substrate at a rate of 0.2 mm/s to a preload of 5 N. For the cases where preload only was applied through displacing the device to contact the substrate (denoted as “Press” in FIG. 3A), the contact was stabilized for 10 s after reaching the preload and then the heater was turned off and the pump was turned on for 4 min, followed by allowing the device to sit for another 4 min. Then the device was pulled-off at a rate of 0.01 mm/s.

For the case where a positive pressure was applied during the preload step (denoted as “6.9 kPa preload” in FIG. 3A), once the preload was reached and the contact was stabilized for 10 s, the heater was turned off and the pump was turned on with an internal chamber pressure of 6.9 kPa for 4 min. After releasing the pressure and allowing the device to sit for another 4 min, the device was pulled-off at a rate of 0.01 mm/s.

For the case where a positive pressure was applied during the preload step and a negative pressure was applied during the stiff-state pull-off step (denoted as “−6.9 kPa pull-off” in FIG. 3A), the preload and cooling steps were the same as the case where a positive pressure was applied during the preload step as discussed above. Once the device was cooled, the inlet tubes were switched to connect to the syringe pump and the device was pulled-off at a rate of 0.01 mm/s with −6.9 kPa pressure maintained within the chamber.

### Soft-State Pull-Off Test Against a Flat Substrate

In a soft-state pull-off test against a flat substrate, the inlet tubes were connected to the syringe pump and the membrane was kept at 70° C. using the controller throughout the test. The SMP membrane was brought into contact with the substrate at a rate of 0.2 mm/s to a preload of 5 N. After stabilizing the contact with 6.9 kPa pressure applied within the chamber for another 30 s, the device was pulled-off at a rate of 0.01 mm/s with a different positive chamber pressure (the value of the pressure was recorded as the gauge value after the device was completely pulled off).

### Thermal Characterization

To measure the temperature of the SMP membrane during experiments to characterize the heating and cooling times, a thermocouple (SA1XL-K-72, Omega Engineering) was attached to the center of the frontside of the SMP membrane and the data was recorded with a data logger (HH309, Omega Engineering). To characterize the heating process, 120 V, 0.28 A was applied to the flexible heater through the controller and the temperature change from room temperature (19° C.) to 70° C. was recorded. To characterize the conduction cooling process where the SMP membrane was cooled passively by the environment, the SMP membrane was heated to 70° C. and then the heater was turned off. The temperature change from 70° C. to room temperature (19° C.) was recorded. To characterize the convection cooling process where the SMP membrane was cooled by airflow generated by the air pump, the SMP membrane was heated to 70° C., then the heater was turned off and the pump was turned on. The temperature change from 70° C. to the temperature of the pumped air (22° C.) was recorded. Note that the operation of the pump heated the air

### Aspects

The following Aspects are illustrative only and do not limit the scope of the present disclosure or the appended claims. Any part or part of any Aspect can be combined with any part or parts or one or more other Aspects.

Aspect 1. A controllable gripper module, comprising:
a chamber;
a flexible membrane at least partially sealing the chamber,
the flexible membrane being in a first state and having a first state modulus when at an ambient temperature and being in a second state and having a second state modulus when at an elevated temperature,
the flexible membrane being reversibly convertible between the first state and the second state, the conversion optionally being effected by application of heat, and
the chamber optionally configured to contain a pressure within that exerts the membrane outward relative to the chamber, optionally while the membrane is at the elevated temperature.

As explained elsewhere herein, a membrane can be heated by contacting the membrane to a heated fluid (gas, liquid) or effecting heating of the membrane by way of a heated fluid. A membrane can also be heated via application of electricity, e.g., to traces on or in the membrane. Application of electricity can thus give rise to membrane heating and/or a change in membrane stiffness; the change in stiffness need not necessarily be accompanied by a change in temperature.

As described elsewhere herein, the chamber can have air flowed therethrough, e.g., to heat and/or cool the flexible membrane. Other fluids can also be flowed through the chamber, e.g., water, ethylene glycol, and the like. Without being bound to any particular theory, a fluid (e.g., a liquid) can give rise to comparatively rapid cooling and heating.

Aspect 2. The module of claim 1, further comprising a heater disposed within the chamber, the heating being configured to effect heating of the flexible membrane.

Aspect 3. The module of claim 2, wherein the heater is located at a distance from the flexible membrane.

Aspect 4. The module of claim 2, wherein (a) the heater comprises an amount of metal, (b) the heater comprises a carbon based conductive ink (e.g., comprising carbon black, carbon nanotube, or graphite), or both (a) and (b). The heater can comprise silver conductive ink; the heater can also comprise copper, e.g., in a pattern such as a serpentine shape so as to render the copper stretchable.

Aspect 5. The module of claim 4, wherein the metal comprises eutectic gallium indium (EGaIn) alloy.

Aspect 6. The module of any one of claims 1-5, wherein the flexible membrane comprises one or more channels therein or thereon, the one or more channels configured to communicate a fluid therein.

Aspect 7. The module of any one of claims 1-6, wherein the flexible membrane comprises one or more conductive traces therein or thereon, the one or more conductive traces being configured to effect heating of the membrane.

Aspect 8. The module of claim 7, wherein the heating includes resistive heating, infrared heating, or any combination thereof.

Aspect 9. The module of claim 7, wherein the heating includes inductive heating.

Aspect 10. The module of any one of claims 1-9, wherein the flexible membrane has a first state modulus that is from about 50 to about 500 (e.g., 300) times the second state modulus of the flexible membrane. As but one example, the soft state for the flexible membrane material used in the illustrative examples herein is 6.9 MPa. The stiff state modulus is 2.1 GPa, with the modulus ratio then being about 300.

As used elsewhere herein, Young's modulus (E) is the ratio of tensile stress to tensile strain. E_{c} is the stiff state modulus measured when the material is below its transition temperature. Eᵣ is the soft state modulus measured when the material is above its transition temperature. These quantities can be measured through standard Dynamic mechanical analysis (DMA) test where the modulus can be measured as a function of the temperature.

Aspect 11. The module of any one of claims 1-10, wherein the flexible membrane includes at least one material that has a Tg in the range of from about −30 to about 90° C., e.g., from about −30 to about 90° C., from about −20 to about 80° C., from about −10 to about 70° C., from about 0 to about 60° C., from about 10 to about 50° C., from about 20 to about 40° C., or even about 30° C. The foregoing values are non-limiting, and are illustrative only.

The Tg can be, in some non-limiting embodiments, a complete change from soft to stiff over 10 or 20° C., e.g. if Tg=60 C, then the material can be fully stiff at 40° C. and fully soft at 70° C. if the transition temperature range was 20° C. A sharp transition can be helpful in some applications but is not a requirement. In some instances, a user may use a gradual transition in modulus from room temperate to a temperature above Tg, as this would allow one to have analog control of the adhesion rather than binary adhesion.

Aspect 12. The module of any one of claims 1-11, further comprising one or more valves configured (a) to modulate a pressure within the chamber, (b) modulate convective cooling of the flexible membrane, or both (a) and (b). The module can include a valve that modulates a pressure within the chamber, a valve that modulates convective cooling of the flexible membrane, or can include both such valves. A single valve can also be used to modulate both a pressure within the chamber and convective cooling of the flexible membrane.

Aspect 13. The module of any one of claims 1-12, further comprising a stage configured to effect relative motion between the membrane and a target object.

The flexible membrane can be, e.g., an epoxy material, such as the material used in the illustrative embodiments included herein. These illustrative embodiments are not limiting, however, as other materials can be used as the flexible membrane.

Exemplary tunable stiffness materials can be found in Levine et al., “Materials with Electroprogrammable Stiffness.” Advanced Materials 33.35 (2021): 2007952.). Example materials include, e.g., thermoplastic elastomers (such as poly(lactic acid and thermoplastic urethanes, as non-limiting examples), shape memory polymers (such as polynorbornene, epoxies, as non-limiting examples), liquid-metal-embedded elastomers, liquid crystal elastomers, thermoresponsive hydrogels, and other materials mentioned in Section 4.2 of the foregoing publication.

Flexible membrane materials can be materials in which the material has a soft state modulus small enough (<10 MPa) to achieve conformal contact with the target object. The higher the stiff state modulus, the higher the adhesion switchability and the high adhesion state adhesion strength (i.e., it can pick up heavier objects).

Flexible membrane materials can be materials in which the transition temperature is higher than the environment temperature, otherwise it is always in soft state at ambient temperature. With a transition temperature above environmental temperature, the lower the transition temperature, the less heat needs to be spent to heat the material above the transition temperature.

Aspect 14. A method, comprising:
with a flexible membrane,
the flexible membrane capable of reversible conversion between a first state and a second state, optionally by application of heat to heat the membrane above a threshold temperature,
the membrane in the first state having a first modulus that is higher than a second modulus of the membrane in the second state,
contacting the flexible membrane in the second state to a first target object; and
effecting adhesion between the flexible membrane and the first target object by placing the flexible membrane in the first state, optionally by placing the membrane at a temperature below the threshold temperature.

The membrane can comprise one or more materials that goes from soft to stiff without heating, e.g., by application of electricity. Thus, one can use in the membrane a material or materials that are convertible from the first (or soft) state to the second (or stiff) state by application of heat, application of electricity, or other gradient. In some embodiments, one can trigger the transition from the stiff state to the soft state with an electrical signal; the electrical signal can create heat, which heat creates mechanical stiffness change.

Aspect 15. The method of claim 14, wherein the contacting is effected by exerting a pressure on the flexible membrane so as to effect contact between the flexible membrane and the first target object.

Contacting can also be effected by, e.g., use of a flexible membrane that is electrically charged or magnetically responsive. In this way, one can then apply an electrostatic force or magnetic force to drive membrane deformation instead of (or in addition to) the application of pressure to the flexible membrane.

Aspect 16. The method of claim 15, wherein the pressure is effected by pressurizing a chamber that is at least partially sealed by the membrane.

Aspect 17. The method of any one of claims 14-16, further comprising placing the flexible membrane into the second state, optionally by heating the flexible membrane so as to heat the flexible membrane to above the threshold temperature.

Aspect 18. The method of claim 17, wherein the heating is effected by actuating a heater in thermal communication with the flexible membrane.

Aspect 19. The method of claim 17, wherein the heating is effected by resistive heating, inductive heating, infrared heating, or any combination thereof of a conductor disposed on or in the flexible membrane.

Aspect 20. The method of any one of claims 14-19, further comprising heating the flexible membrane to above the threshold temperature following adhesion between the flexible membrane and the first target object.

Aspect 21. The method of claim 20, further comprising exerting a pressure on the flexible membrane so as to effect termination of adhesion between the flexible membrane and the first target object.

Aspect 22. The method of any one of claims 14-21, further comprising effecting relative motion between the flexible membrane and the target object before adhesion between the flexible membrane and the first target object.

Aspect 23. The method of any one of claims 14-22, further comprising effecting motion of the first target object while the target object is adhered to the flexible membrane.

Aspect 24. The method of any one of claims 14-23, further comprising contacting the flexible membrane in the second state to a second target object.

Aspect 25. Aspect The method of claim 24, further comprising placing the flexible membrane at a temperature below the threshold temperature so as to effect adhesion between the flexible membrane and the second target object.

Aspect 26. The method of claim 25, further comprising heating the flexible membrane to above the threshold temperature following adhesion between the flexible membrane and the first target object.

1. A controllable gripper module, comprising:
a chamber;
a flexible membrane at least partially sealing the chamber,
the flexible membrane being in a first state and having a first state modulus when at an ambient temperature being in a second state and having a second state modulus when at an elevated temperature,
the flexible membrane being reversibly convertible between the first state and the second state, the conversion optionally being effected by application of heat, and
the chamber optionally configured to contain a pressure within that exerts the membrane outward relative to the chamber, optionally while the membrane is at the elevated temperature.

2. The module of claim 1, further comprising a heater disposed within the chamber, the heater being configured to effect heating of the flexible membrane.

3. (canceled)

4. (canceled)

5. (canceled)

6. The module of claim 1, wherein the flexible membrane comprises one or more channels therein or thereon, the one or more channels configured to communicate a fluid therein.

7. The module of claim 1, wherein the flexible membrane comprises one or more conductive traces therein or thereon, the one or more conductive traces being configured to effect heating of the membrane.

8. (canceled)

9. (canceled)

10. The module of claim 1, wherein the flexible membrane has a first state modulus that is from about 10 to about 1000 times the second state modulus of the flexible membrane.

11. The module of claim 1, wherein the flexible membrane includes at least one material that has a Tg in the range of from about −30 to about 90° C.

12. The module of claim 1, further comprising one or more valves configured to (a) modulate a pressure within the chamber, (b) control convective cooling, or both (a) and (b).

13. The module of claim 1, further comprising a stage configured to effect relative motion between the membrane and a target object.

14. A method, comprising:
with a flexible membrane,
the flexible membrane capable of reversible conversion between a first state and a second state, optionally by application of heat to heat the membrane above a threshold temperature,
the membrane in the first state having a first modulus that is higher than a second modulus of the membrane in the second state,
contacting the flexible membrane in the second state to a first target object; and
effecting adhesion between the flexible membrane and the first target object, optionally by placing the flexible membrane at a temperature below the threshold temperature.

15. The method of claim 14, wherein the contacting is effected by exerting a pressure on the flexible membrane so as to effect contact between the flexible membrane and the first target object.

16. The method of claim 15, wherein the pressure is effected by pressurizing a chamber that is at least partially sealed by the membrane.

17. The method of claim 14, further comprising placing the flexible membrane into the second state, optionally by heating the flexible membrane so as to heat the flexible membrane to above the threshold temperature.

18. (canceled)

19. The method of claim 17, wherein the heating is effective by resistive heating or inductive heating or infrared heating of a conductor disposed on or in the flexible membrane.

20. The method of claim 14, further comprising heating the flexible membrane to above the threshold temperature following adhesion between the flexible membrane and the first target object.

21. The method of claim 20, further comprising exerting a pressure on the flexible membrane so as to effect termination of adhesion between the flexible membrane and the first target object.

22. The method of claim 14, further comprising effecting relative motion between the flexible membrane and the target object before adhesion between the flexible membrane and the first target object.

23. The method of claim 14, further comprising effecting motion of the first target object while the target object is adhered to the flexible membrane.

24. The method of claim 14, further comprising contacting the flexible membrane in the second state to a second target object.

25. The method of claim 24, further comprising placing the flexible membrane at a temperature below the threshold temperature so as to effect adhesion between the flexible membrane and the second target object.

26. The method of claim 25, further comprising heating the flexible membrane to above the threshold temperature following adhesion between the flexible membrane and the first target object.
